(19) United States
(12) Patent Application Publication
(10) Pub. No.: US 2014/0088982 A1
(43) Pub. Date: Mar. 27, 2014

(54) MEDICATION-CONFLICT-DETECTION APPARATUS AND METHOD

(71) Applicants: Stuart Argue, Bentonville, AR (US); Anthony Emile, San Francisco, CA (US)

(72) Inventors: Stuart Argue, Bentonville, AR (US); Anthony Emile, San Francisco, CA (US)

(73) Assignee: Wal-Mart Stores, Inc., Bentonville, AR (US)

(21) Appl. No.: 13/629,423

(22) Filed: Sep. 27, 2012

(51) Int. Cl. G06Q 30/02; G06Q 50/22

(52) U.S. Cl. CPC G06Q 30/0281; G06Q 50/22
USPC 705/2

(57) ABSTRACT

A method for using receipt data to identify medication conflicts is disclosed. The method may begin with linking, by a computer system, a human customer to a first substance. Subsequently, the computer system may initiate a purchase transaction involving the human customer. During the transaction, the computer system may identify a second substance forming part of the purchase transaction. Accordingly, the computer system may find, within a conflicts database, a conflict between the first and second substances. The conflict may correspond to an undesirable effect produced by simultaneous use of the first and second substances. The computer system may then alert the human customer to the conflict.

### BACKGROUND

1. Field of the Invention

This invention relates to conflict detection and warning systems and more particularly to systems and methods for leveraging receipt data to identify potential conflicts in medications and other substances corresponding to a particular customer.

2. Background of the Invention

Many point-of-sale (POS) and back office systems currently in use today do not support important emerging technologies, services, and marketing opportunities. For example, many POS and back office systems are limited in their ability to leverage the electronic receipt data they collect. Accordingly, what is needed is an apparatus and method expanding the ability of a wide variety of POS and back office systems, include legacy systems, to make improved use of the receipt data they collect.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of a receipt in accordance with the present invention;

FIG. 4 is a schematic block diagram of one embodiment of a receipt module in accordance with the present invention;

FIG. 5 is a schematic block diagram of one embodiment of a conflicts module in accordance with the present invention;

FIG. 6 is a block diagram of one embodiment of a method for leveraging electronic receipt data to identify potential conflicts between two or more substances and warn an appropriate customer;

FIG. 7 is a schematic diagram illustrating the flow of certain data within one embodiment of a system in accordance with the present invention;

FIG. 8 is a schematic diagram illustrating the flow of certain data within an alternative embodiment of a system in accordance with the present invention;

FIG. 9 is a schematic diagram illustrating the flow of certain data within another alternative embodiment of a system in accordance with the present invention;

FIG. 10 is a block diagram of one embodiment of a method for a pre-purchase scan to identify potential conflicts between two or more substances and warn an appropriate customer; and

FIG. 11 is a schematic diagram illustrating the flow of certain data within another alternative embodiment of a system in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for leveraging receipt data collected at a POS. For example, in selected embodiments, a customer may enter a “brick-and-mortar” business location and approach a POS system to begin a transaction. As part of the transaction, the customer may be identified and receipt data may be generated. The receipt data may identify one or more items purchased by the customer. Identification information may link a customer and receipt data corresponding thereto.

In selected embodiments, receipt data may be leveraged by a computer system in generating an alert warning a customer corresponding to the receipt data of potential conflicts or harmful interactions between substances (e.g., medications) the customer has purchased. For example, an alert may advise a customer that a medication he or she purchased today may cause harm when used concurrently with a medication the customer purchased some time previously.

One method in accordance with the present invention may begin with a customer entering a “brick-and-mortar” business and approaching a POS system. At the POS system, a transaction (e.g., a purchase) may be initiated. As part of the transaction, a customer may be identified. Identification information may be passed from a POS system to one or more other computers within a computer system. The identification information may link a customer and a corresponding transaction to one or more records stored within the computer system. In selected embodiments, such records may contain the information necessary to identify and communicate with a computing device of the corresponding customer.

After a transaction has been initiated, one or more potentially conflicting substances (e.g., medications) may be identified as forming part of the transaction. Using the potentially conflicting substances that are identified, one or more computers may search for and identify one or more conflicts. In selected embodiments, this may entail identifying one or more conflicts between substances forming part of the transaction. Alternatively, this may entail identifying one or more conflicts between one or more substances forming part of the transaction and one or more substances purchased or obtained by the customer in one or more previous transactions.

Once a conflict has been identified, a customer may be informed of the conflict. In selected embodiments, a computer system in accordance with the present invention may inform a customer of a conflict as soon as possible after a conflict is identified. For example, the customer may be informed (e.g., via a push notification or the like) before the completion of the transaction. Accordingly, the customer may elect to remove a particular substance from the transaction. Alternatively, a customer may be informed of a potential conflict some time after completion of the transaction.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

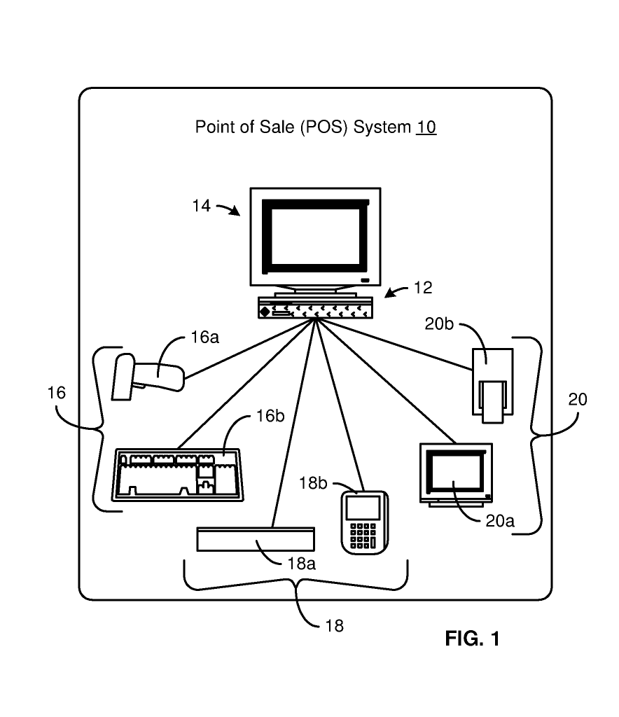

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support collection of receipt data that can be used to warn customers about potential medication conflicts.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

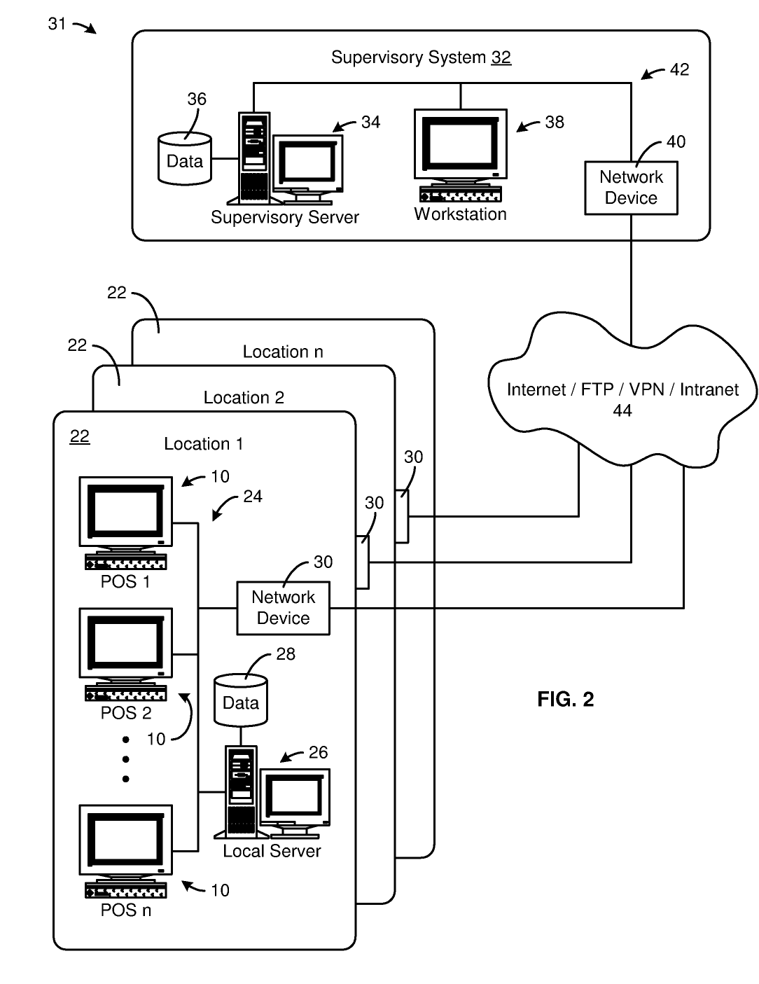

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

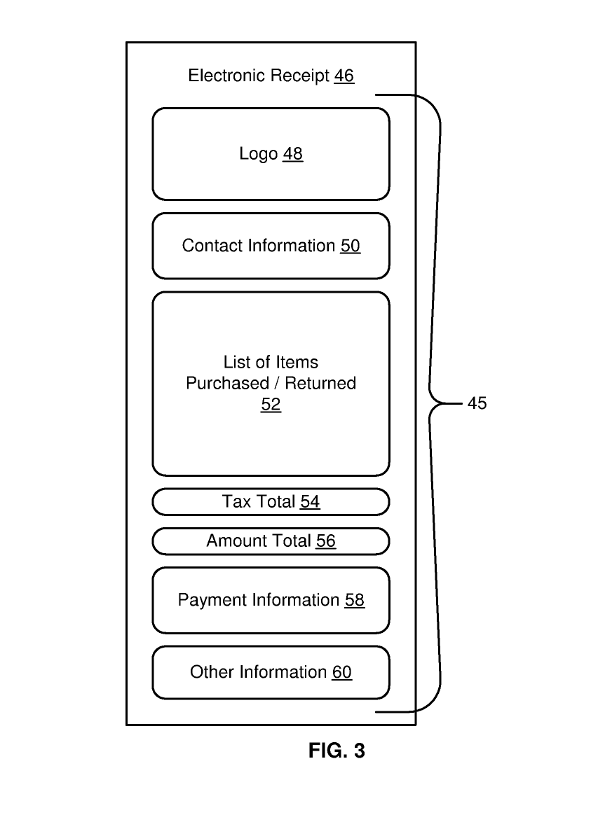

Referring to FIG. 3, a POS system 10 may collect and/or generate receipt data 45. Receipt data 45 may document a transaction (e.g., sale or return) carried out by a POS system 10. Receipt data 45 may be presented or displayed to a customer in the form of an electronic (e.g., paperless) receipt 46. In selected embodiments, receipt data 45 may be delivered to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 10, local servers 26, supervisory servers 34, some other onsite resources, some other offsite resources, or the like or combinations or sub-combinations thereof, hereinafter a “computer system”).

In selected embodiments, receipt data 45 and an electronic receipt 46 may include a logo 48, contact information 50, a list 52 of items purchased or returned, a total 54 indicating the sales tax assessed or returned, a total 56 indicating the amount paid or returned, payment information 58, other information 60, or the like or combinations or sub-combinations thereof.

A logo 48 may reinforce the brand and image of the associated entity within the mind of a consumer. By including contact information 50 on an electronic receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within an electronic receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

An electronic receipt 46 may be presented by a computing device of a customer in any suitable layout or format. For example, the receipt data 45 forming an electronic receipt 46 may simply be presented as a textual list. Alternatively, an electronic receipt 46 may follow the form of a paper receipt. That is, the electronic receipt 46 may comprise a virtual representation or layout substantially matching what a comparable paper receipt would look like.

The manner in which an electronic receipt 46 is presented or displayed on a computing device of a customer may be completely dictated by the computer system delivering the receipt data 45 thereto. Alternatively, the computing device of the customer may have an application (e.g., a receipt manager, accounting program, budgeting program, or the like) installed thereon. Such an application may partially or completely control the layout or format of an electronic receipt 46 displayed therewith or therethrough. For example, a computer system may supply receipt data 45, while the application installed on the computing device of the customer supplies the layout or formatting.

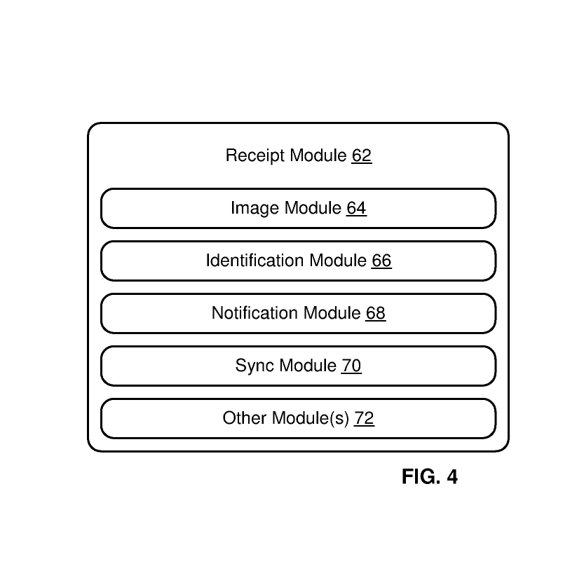

Referring to FIG. 4, a computer system in accordance with the present invention may deliver receipt data 45 to a computing device of a customer in any suitable manner. In selected embodiments, a receipt module 62 may enable or support such delivery. A receipt module 62 may include any suitable arrangement of sub-components or modules. In certain embodiments, a receipt module 62 may include an image module 64, identification module 66, notification module 68, synchronization module 70, one or more other modules 72 as desired or necessary, or the like or some combination or sub-combination thereof.

An image module 64 may assemble, generate, or obtain an advertisement containing a call to action for display on a receipt (e.g., paper receipt), customer-facing display 20a, or the like. In selected embodiments, a call to action may invite or motive a consumer to download receipt data 45. To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 45 encoded within the code. Alternatively, scanning the code may initiate the download of receipt data 45.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 66 may be tasked with requesting, collecting, and/or communicating identification information linking a customer associated with a transaction with one or more records stored within a computer system. For example, as part of a transaction carried out at a POS system 10, an identification module 66 may request, collect, and/or communicate identification information linking a transaction to a particular computing device corresponding to the customer participating in the transaction. Thus, information corresponding to the transaction may be passed to the customer via the particular computing device.

An identification module 66 may request, collect, and/or communicate one or more types of identification information. For example, in selected embodiments, an identification module 66 may collect a unique identification or membership number from a customer. This may be done when a membership card, club card, loyalty card, identification card, credit card, debit card, fingerprint or other biometric characteristic, or the like is scanned, input, or otherwise collected at a POS system 10. In other situations, a cashier or customer may type in a unique identification number, payment number, membership number, or the like at a POS system 10. For example, while a cashier is processing a transaction, a customer may be prompted via a card reader 18b, customer-facing display 20, or the like to enter (e.g., type in using the card reader 18b) a mobile telephone number corresponding to the customer. Alternatively, a cashier may type in a telephone number corresponding to the customer.

Once the identification information is received, it may be used directly (e.g., used directly to pass receipt data 45 to a computing device of a corresponding customer). Alternatively, or in addition thereto, the identification information may be linked to one or more previously stored computer records. Within such records, a computer system may find the information necessary to identify and communicate with a computing device of a corresponding customer.

A notification module 68 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 46 is available for download).

A synchronization module 70 may support or enable one way or two way data communication between a computer system and a computing device. For example, a synchronization module 70 may support or enable the passing of receipt data 45 from a computer system to a computing device. A synchronization module 70 may also enable certain data received from a computing device to be incorporated within or used by a computer system. For example, one or more user preferences (e.g., notification preferences) may be communicated to a computer system from an application resident on a computing device.

The various functions or modules of a receipt module 62 may be enacted or implemented by any suitable system or component thereof. For example, in selected embodiments, one or more functions or modules of a receipt module 62 may be distributed across one or more hardware devices, including a primary computer 12 of a POS system 10, a local server 26, a supervisory server 34, some other onsite resource, some other offsite resource, or the like or combinations or sub-combinations thereof. Thus, systems and methods in accordance with the present invention may be adapted to a wide variety of situations, including more rigid legacy systems.

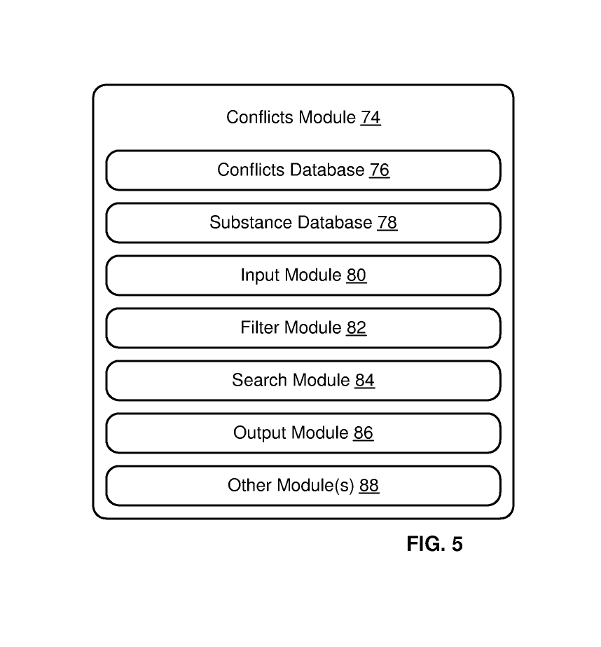

Referring to FIG. 5, conflicts or unwanted interactions between two or more substances can result in serious health problems. For example, a medication (e.g., drug) may be taken in a prescribed quantity, but its effects may be altered by the simultaneous use or presence of another medication or substance. The altered effects may produce a wide range of outcomes from something as small as intestinal discomfort to something as catastrophic as death.

Conflicts can arise between various substances. For example, conflicts may exist between two medications (e.g., drug-to-drug conflicts). However, other conflicts such as drug-to-supplement, drug-to-food, and drug-to-alcohol conflicts and interactions have been found to cause harm. As one would expect, the more medications a patient takes, the greater the chance that the patient will encounter a conflict or harmful interaction. In the United States, it is said that nearly 40% of the population is taking four or more different medications. Accordingly, the risk associated with medication conflicts is substantial.

A computer system, computing device, or some combination thereof in accordance with the present invention may assist in alerting or warning a customer to one or more potentially harmful conflicts. In selected embodiments, a conflicts module 74 may enable or support such alerts or warnings. The functionality of a conflicts module 74 may be performed by a computer system, computing device, or some combination thereof. A conflicts module 74 may include any suitable arrangement of sub-components or modules. In certain embodiments, a conflicts module 74 may include a conflicts database 76, substance database 78, input module 80, filter module 82, search module 84, output module 86, one or more other modules 88 as desired or necessary, or the like or some combination or sub-combination thereof.

A conflicts database 76 may contain records identifying one or more conflicts. In selected embodiments, a conflicts database 76 may contain records identifying two or more substances (e.g., topical treatments, over-the-counter medications, prescription medications, ingestible substances such as drugs, foods, or beverages, or the like) whose concurrent use or presence may produce a harmful result or effect. A conflicts database 76 may also contain records identifying the harmful result or effect.

For example, in selected embodiments, a conflicts database 76 may contain records indicating that amiodarone (e.g., PACERONE, CORDARONE) conflicts with simvastatin (e.g., ZOCOR), Vitamin E conflicts with warfarin (e.g., COUMADIN, JANTOVEN, MAREVAN, LAWARIN, WARAN, WARFANT), simvastatin conflicts with grapefruit (i.e., furanocoumarins contained within grapefruit), and the like. A conflicts database 76 may also contain records indicating that concurrent use of amiodrone and simvastatin can lead to kidney failure or death, concurrent use of Vitamin E and warfarin can increase the blood-thinning properties of warfarin and the risk of bleeding, concurrent use of simvastatin and grapefruit can slow metabolization of simvastatin resulting in higher plasma levels of the drug and a risk of toxicity, and the like.

A conflicts database 76 may identify and index substances in any suitable manner. In selected embodiments, substances may be identified and/or indexed based on a name. For example, a particular substance may be indexed under its generic name, one or more trade names applied to it, the name of one or more overarching substances (e.g., compounds, foods, supplements, etc.) that contain it, or the like or some combination or sub-combination thereof.

In other embodiments, substances may be identified and/or indexed based on an identification number or code (e.g., a Chemical Abstracts Service (CAS) Registry Number, Anatomical Therapeutic Chemical (ATC) Code, Universal Product Code (UPC) or the like). In still other embodiments, substances may be identified and/or indexed using a combination or sub-combination of generic names, trade names, identification numbers or codes, and the like. Accordingly, a substance like simvastatin may be linked within a conflicts database 76 to the trade name “ZOCOR,” the CAS number “79902-63-9,” the ATC code “C10AA01,” or the like or some combination or sub-combination thereof.

A substance database 78 may contain records linking one or more customers to one or more substances. Records within a substance database 78 may be created in any suitable manner. In selected embodiments, an input module 80 may be tasked within creating certain records within a substance database 78. In certain situations or applications, an input module 80 may autonomously or automatically create such records.

For example, a customer may purchase a substance relevant to a conflicts database 76 (e.g., a substance contained or identified within a conflicts database 76) at a brick-and-mortar store, an online store, or the like. During the purchase, identification information identifying the customer may be collected (e.g., by an identification module 66). Accordingly, an input module 80 may automatically create a record within a substance database 78 linking the particular customer to the substance. Should the customer make additional purchases of one or more substances relevant to a conflicts database 76, the substance database 78 may be automatically updated to link the customer to such substances.

In certain situations or applications, an input module 80 may support a manually or customer-initiated creation of records within a substance database 78. For example, an input module 80 may enable a customer to enter one or more medications he or she (or a family member) is taking A customer may also enter certain dosing information (e.g., the frequency, quantity, or the like) associated with one or more medications. Additionally, a customer may enter one or more designations assigning different medications to different members of a household or family. This may be performed outside of any purchase. For example, a customer may simply open a medicine cabinet and enter in the various medications.

In selected embodiments, such entering may be accomplished by typing in the name or identification code of one or more medications using a computing device in the procession of the customer. Alternatively, an input module 80 may enable a customer to scan the barcode associated with one or more medications (e.g., scan the barcode using a camera of a computing device). Using the information typed in by the customer, extracted from the barcode, or the like, an input module 80 may create an appropriate record within a substance database 78.

In certain embodiments, a conflicts module 74 may include a filter module 82. When included, a filter module 82 may work to filter selected data to identify information that may be relevant to the function of one or more other components of a conflicts module 74. For example, in selected embodiments, a filter module 82 may analyze or process receipt data 45 to identify any items identified therein that may contain a substance relevant to a conflicts database 76.

A search module 84 may be programmed to determine whether a first substance (e.g., a first ingestible substance) could present a conflict or harmful interaction for a particular customer. A search module 84 may accomplish this in any suitable manner. For example, in selected embodiments, a search module 84 may query a conflicts database 76 to identify any second substances (e.g., one or more second ingestible substances) that conflicts with the first substance. The search module 84 may then query (e.g., query a substance database 78) to determine whether any of the second substances correspond to the customer. This may be accomplished by determining whether any of the second substances have been input by the customer, purchased in the past by the customer, are being purchased presently by the customer, or the like.

In selected embodiments, a search module 84 may receive certain inputs or information from a filter module 82. For example, a filter module 82 may determine when an item (e.g., an item scanned pre-purchase by a customer, an item listed in receipt data 45, or the like) contains a substance relevant to a conflicts database 76. When items containing such substances are identified, they may be communicated to a search module 84 for further processing.

Alternatively, in certain embodiments, a filtering module 82 may be incorporated within the functionality of a search module 84. In such embodiments, a first query issued by a search module 84 may be whether a particular item contains a substance relevant to a conflicts database 76. If the item does contain the substance, additional queries may be made by a search module 84 to identify one or more conflicting substances and determine whether any of the conflicting substances correspond to the customer.

An output module 86 may support, coordinate, generate, or control one or more outputs from a conflicts module 74. In selected embodiments, an output module 86 may generate and/or send an alert or warning informing a customer about a potential conflict or harmful interaction. For example, an output module 86 may support, generate, initiate, authorize, and/or send a notice (e.g., push notification) to a computing device of the customer. Such a notice may identify two or more substances and state what harm may result from concurrent use thereof.

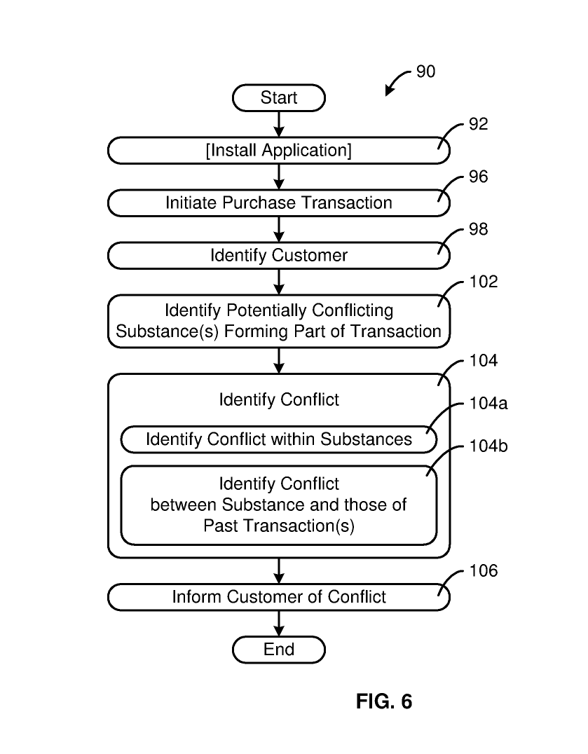

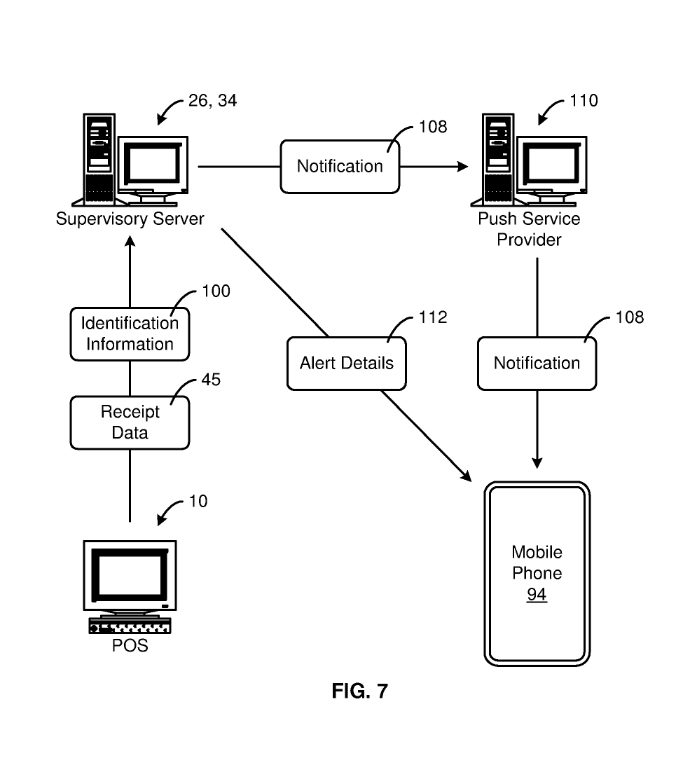

Referring to FIGS. 6 and 7, one method 90 in accordance with the present invention may begin when an application is installed 92 on a computing device 94 (e.g., a mobile telephone 94). In selected embodiments, the application may be programmed to receive, format, display, categorize, and/or analyze receipt data 45. Alternatively, or in addition thereto, the application may be programmed to generate or receive one or more alerts warning of possible conflicts between two or more substances.

Within the method 90, a customer may enter a “brick-and-mortar” business location (e.g., a brick-and-mortar retail store) and approach a POS system 10. At the POS system 10, a transaction (e.g., a purchase) may be initiated 96. As part of a transaction, a customer may be identified 98. For example, a POS system 10 may scan a membership card, club card, loyalty card, identification card, credit card, debit card, fingerprint, or the like. From the scan, identification information 100 (e.g., a unique identification, card, or membership number) may be obtained. Alternatively, while a cashier is processing a transaction, a customer may be prompted via a card reader 18b, customer-facing display 20, or the like to enter (e.g., type in using the card reader 18b) an identification number (e.g., a mobile telephone number).

Identification information 100 may be passed from a POS system 10 to one or more other computers (e.g., servers 26, 34) within a computer system. The identification information 10 may link a customer and a corresponding transaction to one or more records stored within a computer system. In selected embodiments, such records may contain the information necessary to identify and communicate with a computing device 94 of the corresponding customer.

After a transaction has been initiated 96, one or more items may be identified by a POS system 10. In selected embodiments, bar codes of one or more items may be scanned by a scanner 16a of a POS system 10. Accordingly, one or more potentially conflicting substances (e.g., medications) may be identified 102 as forming part of the transaction. For example, receipt data 45 identifying the items forming part of the transaction may be passed from a POS system 10 to one or more other computers (e.g., servers 26, 34 or the like executing all or some portion of a conflicts module 74) within a computer system. Accordingly, an analysis of the receipt data 45 may enable one or more computers to identify 102 one or more potentially conflicting substances forming part of the transaction.

Using the potentially conflicting substances identified 102, one or more computers (e.g., servers 26, 34) may search for and identify 104 (when present) one or more conflicts. In selected embodiments, this may entail identifying 104a one or more conflicts between substances forming part of the transaction (e.g., the current or present transaction). Alternatively, this may entail identifying 104b one or more conflicts between one or more substances forming part of the transaction and one or more substances purchased or obtained in one or more previous transactions.

Once a conflict has been identified 104, a customer may be informed 106 of the conflict. A customer may be so informed in any suitable manner. In selected embodiments, a push notification 108 may be used. For example, a push notification 108 may be generated and sent to an appropriate computing device 94. In selected embodiments, a push notification 108 may be a short message comprising a device token and a payload. A device token may contain information that enables a push service provider 110 (e.g., Apple Push Notification Service, Android Cloud to Device Messaging (C2DM), or the like) to locate the appropriate computing device 94 on which the application is installed 92. A device token may also permit a push service provide 110 to authenticate the routing of a push notification 108.

A payload of a push notification 108 may comprise various data. In general, the nature and extent of the payload may be controlled by the specifications and features imposed or provided by a push service provider 110. Some providers 110 may support significantly more data and/or functionality in association with push notifications 108. In selected embodiments, a payload may comprise a property list specifying how a customer associated with the computing deice 94 is to be alerted. For example, a payload may specify an alert message to display to the customer (e.g., “Warning! You have purchased a medication that may be harmful if taken with other medications in your home.”), a number with which to badge the application icon, a notification sound or vibration to play or execute, or the like.

Once a push notification 108 is received by a computing device 94, a customer may choose how he or she would like to respond. For example, in viewing an alert generated on a computing device 94 by a push notification 108, a customer may be presented with the options of closing the alert and launching the corresponding application. Should the customer elect to close the alert, the alert may be closed and the computing device 94 may wait until the next launch to obtain or download the details 112 of the alert (e.g., the specifics regarding which substances form the basis of the conflict, the potential harm associated with the conflict, etc.).

If the customer elects to launch the application, then the application may be launched on the computing device 94. In selected embodiments, the launching of the application may automatically trigger download of the alert details 112. Accordingly, the customer may be informed 106 of the conflict and the alert details 112 may be presented to the customer. In certain embodiments, a customer may be granted one or more ways to response to the alert and/or alert details 112.

For example, an “I am no longer taking this” button, a “No one in my house is taking this” button, or a “John is no longer taking this” button may be presented. (In such embodiments, use of a proper name may result when a customer has assigned a particular substance to a particular person.) If the customer selects this button, the corresponding substance may be removed from the appropriate record(s) within the substance database 78. An “I am taking this” button, a “Someone in my house is taking this” button, or a “Jen is taking this” button may also be presented. Should the customer select this button, he or she may be directed to certain relevant information (e.g., information stating that Medication A should not be taken within a certain temporal proximity of Medication B or the like). In selected embodiments, when responding to an alert or certain alert details 112, a customer may be prompted to assign new medications to particular persons or members of a family or household.

In selected embodiments, a computer system in accordance with the present invention may inform 106 a customer of a conflict as soon as possible after a conflict is identified. In selected embodiments, the customer may be informed 106 before the completion of the transaction. Accordingly, the customer may elect to remove a particular substance from the transaction.

Alternatively, a customer may be informed 106 of a potential conflict shortly after completion of the transaction. For example, a push notification 108 may be sent substantially immediately upon completion (e.g., within one second or less of completion 86). In such embodiments, a push notification 108 may typically be received by a computing device 94 very shortly after completion (e.g., within four seconds and preferably within about two seconds of completion). Accordingly, if a customer is carrying the corresponding computing device 94 on his or her person within the brick-and-mortar location, the customer may be alerted (e.g., by sound, vibration, or the like) within the time it would typically require to print a paper receipt.

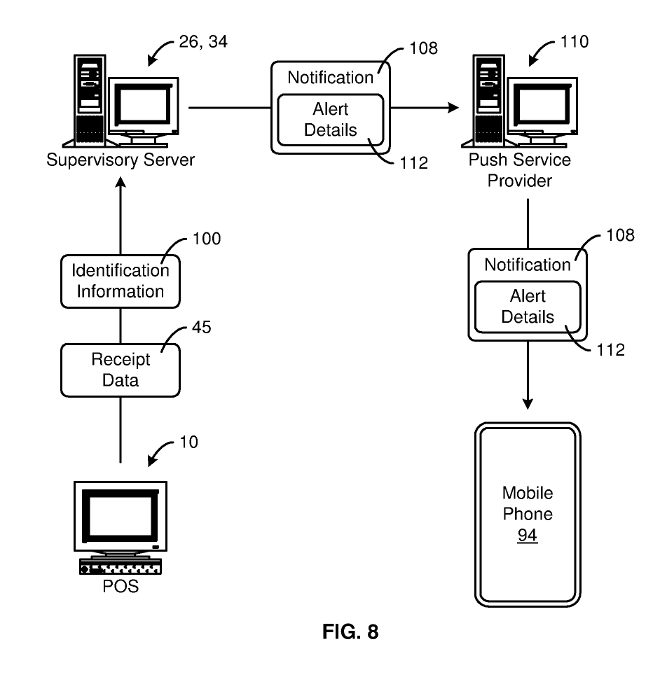

Referring to FIG. 8, in selected alternative embodiments, a push notification 108 may carry significantly more data (e.g., payload) than simply an alert message, alert sound, and the like. For example, a push notification 108 may carry certain details 112 of a conflict to a computing device 94. In certain embodiments, such a push notification 108 may prompt a customer to launch an application in order to receive, store, and/or display all of the details 112 carried in the push notification 88.

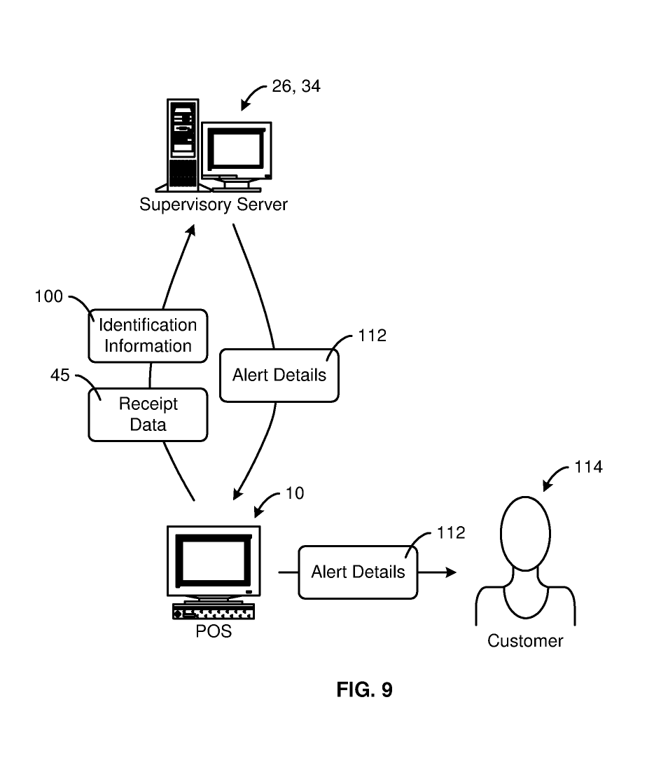

Referring to FIG. 9, in selected embodiments, a conflict may be communicated to a customer 114 without involving any computing device 94 possessed by the customer 114. For example, receipt data 45 identifying the items forming part of the transaction may be passed from a POS system 10 to one or more other computers (e.g., servers 26, 34 or the like executing all or some portion of a conflicts module 74) within a computer system. Accordingly, an analysis of the receipt data 45 may enable one or more computers to identify 102 one or more potentially conflicting substances forming part of the transaction. Once a conflict has been identified 104, certain alert details 112 may be communicated to a POS system 10. The POS system 10 may then inform 106 the customer 114 of the potential conflict and communicate the alert details 112 to the customer 114.

A POS system 10 may inform 106 of a potential conflict in any suitable manner. For example, a customer facing display 20a of a POS system 10 may be used to present certain alert details 112 to a customer 114. This may occur during a transaction. Alternatively, or in addition thereto, a receipt issued by a POS system 10 to a customer 114 may contain or present certain alert details 112.

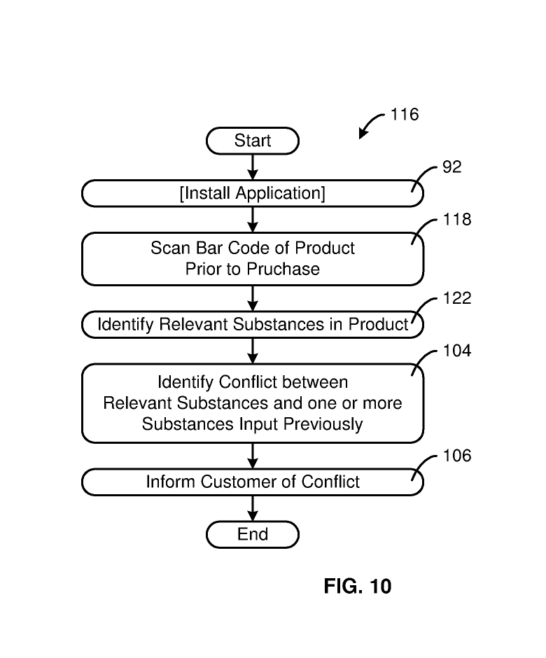

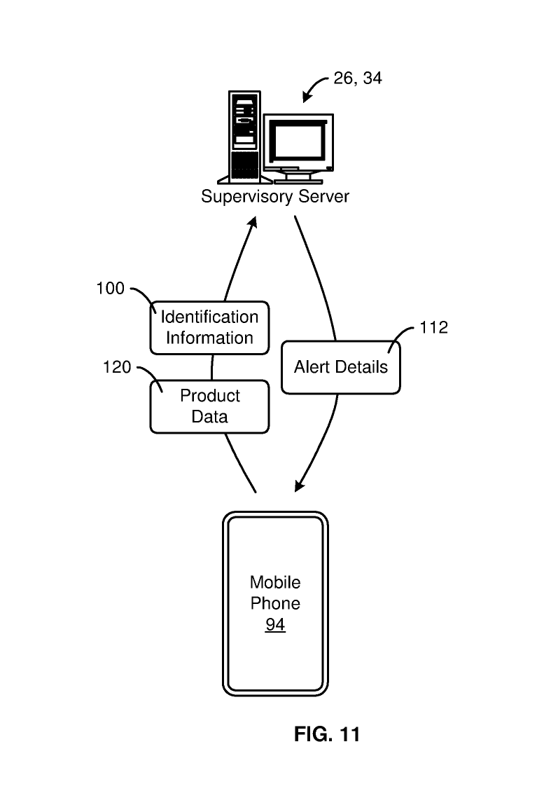

Referring to FIGS. 10 and 11, certain methods in accordance with the present invention may not involve a POS system 10. One such method 116 may enable a customer to identify one or more potential conflicts before deciding to purchase a particular item. For example, while shopping within a brick-and-mortar location, a customer may select a product he or she desires to investigate. Accordingly, the customer may scan 118 a bar code of the product (e.g., scan a bar code using a camera of a computing device 94) and import product data 120 encoded within the code.

In selected embodiments, certain identification information 100 and product data 120 may be passed from a computing device 94 to one or more other computers (e.g., servers 26, 34 or the like executing all or some portion of a conflicts module 74) within a computer system. Accordingly, an analysis of the product data 120 may enable one or more computers to identify 122 one or more potentially conflicting substances found in the product. Using the identity of the one or more potentially conflicting substances, one or more conflicts may be identified 104. Certain alert details 112 may then be communicated to the computing device 94 of the customer so that the customer may be informed 106 of the potential conflict.

In other embodiments, more of the functionality or components of a conflicts module 74 may reside on a computing device 94 of a customer. Accordingly, in certain embodiments, a method 116 may be performed substantially entirely by a computing device 94 of a customer. Alternatively, a computing device 94 of a customer may perform a significant portion of the analysis involved, but rely on one or more outside resources (e.g., servers 26, 34 or the like) for certain data, answers to certain queries, or certain analysis.

The flowcharts and block diagrams in FIGS. 6-11 illustrate the architecture, functionality, and operation of possible implementations of systems, methods, and computer program products according to certain embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for detecting medication conflicts, the method comprising:
linking, by a computer system, a human customer to a first substance;
initiating, by the computer system, a current purchase transaction involving the human customer;
identifying, by the computer system, a second substance forming part of the current purchase transaction;
finding, by the computer system within a conflicts database, a conflict between the first and second substances, the conflict corresponding to an undesirable effect produced by simultaneous use of the first and second substances; and
alerting, by the computer system, the human customer to the conflict.

2. The method of claim 1, wherein the first and second substances comprise first and second medications, respectively.

3. The method of claim 1, wherein at least one of the first and second substances comprises a medication.

4. The method of claim 3, wherein the initiating comprises initiating the current purchase transaction with the human customer within a brick-and-mortar store.

5. The method of claim 4, wherein the identifying comprises scanning, by the computer system, a barcode corresponding to the second substance.

6. The method of claim 5, wherein the linking comprises scanning, by the computer system, a barcode corresponding to the first substance.

7. The method of claim 6, wherein the scanning of the barcode corresponding to the second substance occurs within the brick-and-mortar store.

8. The method of claim 7, wherein the scanning of the barcode corresponding to the first substance precedes the scanning of the barcode corresponding to the second substance.

9. The method of claim 8, wherein the scanning of the barcode corresponding to the first substance forms part of a previous purchase transaction occurring one or more days prior to the current purchase transaction.

10. The method of claim 9, wherein the scanning of the barcode corresponding to the first substance occurs within the brick-and-mortar store.

11. The method of claim 6, wherein the scanning of the barcode corresponding to the first substance forms occurs within a home of the human customer.

12. The method of claim 11, wherein the scanning of the barcode corresponding to the second substance precedes the scanning of the barcode corresponding to the first substance.

13. The method of claim 1, wherein the computer system comprises software running on a mobile computing device of the human customer.

14. The method of claim 1, wherein the alerting comprises passing a message to a mobile computing device of the human customer.

15. A method for detecting medication conflicts, the method comprising:
storing, by a computer system, receipt data documenting a purchase of a first medication by a human customer;
initiating, by the computer system after the storing, a subsequent purchase involving the human customer;
identifying, by the computer system, a second medication forming part of the subsequent purchase;
searching, by the computer system within a conflicts database, for any conflict between the first and second medications;
finding, by the computer system within the conflicts database, a conflict between the first and second medications, the conflict corresponding to an undesirable effect produced by simultaneous use of the first and second medications;
passing, by the computer system, a message to a mobile computing device in the possession of the human customer; and
alerting, by the computer system via the message, the human customer to the conflict.

16. The method of claim 15, wherein the computer system comprises software running on the mobile computing device.

17. The method of claim 16, wherein the initiating comprises initiating the subsequent purchase with the human customer within a brick-and-mortar store.

18. The method of claim 17, wherein the identifying comprises scanning, by the computer system, a barcode corresponding to the second medication.

19. The method of claim 18, wherein the purchase of a first medication occurs within the brick-and-mortar store.

20. A computer system comprising:
one or more processors;
one or more memory devices operably connected to the one or more processors; and
the one or more memory devices collectively storing
a conflicts database identifying one or more conflicts between two or more medications,
a plurality of records, each record thereof linking at least one medication to a human customer who purchased in a prior purchase the at least one medication,
a search module programmed to query the conflicts database to identify any conflicts between one or more medications forming part of a current purchase and one or more medications of one or more prior purchases; and
an output module programmed to communicate any conflicts to one or more mobile computing devices of human customers corresponding to such conflicts.
